(19) United States
(12) Patent Application Publication
(10) Pub. No.: US 2021/0122481 A1
(43) Pub. Date: Apr. 29, 2021

(54) SLIDE DESIGN WITH INTEGRATED EXTENSION TUBE PORTIONS

(71) Applicant: Air Cruisers Company, LLC, Wall Township, NJ (US)

(72) Inventors: Robert J. Biro, Brick, NJ (US); Andreas P. Luethi, Jamesburg, NJ (US)

(21) Appl. No.: 17/036,762

(22) Filed: Sep. 29, 2020

Related U.S. Application Data
(60) Provisional application No. 62/925,521, filed on Oct. 24, 2019.

(51) Int. Cl. B64D 25/14

(52) U.S. Cl. CPC B64D 25/14

(57) ABSTRACT

An evacuation slide that improves beam strength and exit characteristics. Providing an additional tube at the runway end of the slide helps maintain the elevation at the runway end of the slide and supports the end of the slide under load, which facilitates evacuees' ability to easily stand and move away from the runway end of the slide.

This application claims the benefit of U.S. Provisional Application Ser. No. 62/925,521, filed Oct. 24, 2019, titled “Improved Runway End Slide Design with Integrated Extension Tube Portions,” the entire contents of which are hereby incorporated by reference.

### FIELD OF THE DISCLOSURE

This disclosure is related to inflatable evacuation slides and/or slide/rafts for aircraft. The evacuation slide disclosed improves beam strength and exit characteristics. Providing an additional tube at the runway end of the slide helps maintain the elevation at the runway end of the slide and supports the end of the slide under load, which facilitates evacuees' ability to easily stand and move away from the runway end of the slide.

### BACKGROUND

Aircraft often carry hundreds of passengers, and safety regulations require that, in the event of an emergency, all passengers must be able to evacuate from the aircraft in the shortest possible period of time. Inflatable evacuation slides are used on board passenger-carrying aircraft in order to provide a way for passengers to rapidly evacuate the aircraft in emergency situations. Regulations typically set minimum time requirements in which complete evacuation of the aircraft must take place. Evacuation slides are thus designed to increase evacuation rate.

The descent of evacuees via an inflatable evacuation slide is governed in part by the sliding angle formed between the sliding surface of the inflatable slide and the ground. At a shallow sliding angle, rate of descent may be too slow for safety and to meet required regulations. A shallow sliding angle may also increase load on the slide. On the other hand, at a steep sliding angle, the sliding surface may be too precipitous, causing evacuees to be reluctant to use the slide. Additionally, if the sliding angle is too steep, injuries may result upon impact with the ground.

Another challenge that evacuation slide designers face is that in various emergency landing situations, the height of the door may be variable and difficult to predict. For example, after an emergency landing, the aircraft may have a nose up position in which the maximum sill height of the front doors would exceed the normal sill height. Therefore, slides used at the forward doors of aircraft would require substantially greater length than the slides used at the aft doors, which can result in a shallower sliding angle than at the normal sill height. It is also possible that landing gear and engines could be damaged or collapsed such that the aircraft fuselage is canted. This can result in the height of the evacuation doors varying significantly, depending upon the type of plane and the character of the accident.

One successful attempt at an evacuation slide that addresses sliding angle and various exit door heights is shown and described by U.S. Pat. No. 5,875,868, owned by the present assignee, the contents of which are hereby incorporated by reference. As is shown by FIG. 8, this patent provides longitudinal support beams 14, 16, supporting a sliding surface 24. Transverse support beams 18, 20, and 22 also help provide support. At the runway end of the sliding surface, extensions 38, 40 flare out to form a passenger receiving area 39, and the extension portions extend past the sliding surface. This slide design may be referred to in the industry as a “pickle fork” design, because the two extension portions resemble prongs of a small fork. Extension portions 38, 40 help increase the effective length of the slide and provide an acceptable sliding angle when the slide is used at a sill height above normal level. Once a sliding passenger reaches the runway end of the slide, the passenger will be seated upon the transverse support member 20 with his/her feet situated in the passenger receiving area 39 and hands guided by extension portions 38 and 40. This helps provide a smooth exit.

Although a successful solution, it has been found that when evacuation requirements are increased (for example, when raised from a minimum requirement of evacuating an initial number of people to higher evacuation rates for a higher density aircraft), improvements to the pickle fork design may be useful.

### SUMMARY

Accordingly, the present inventors have designed an improvement to the “pickle fork” evacuation slide that reduces the effective sliding length (beam) and helps improve exit characteristics. This is achieved by adding an additional tube positioned under a lower inflatable transverse member. The additional tube may be positioned so that it is offset from the lower inflatable transverse member. The additional tube and the lower inflatable transverse member may be in a stacked configuration. The additional tube contacts the ground during evacuation and can help raise evacuees. Providing the additional tube effectively shortens the sliding length (beam) and supports the lower inflatable transverse member, preventing collapse of the longitudinal body tube extension portions under load. This additional tube increases or maintains the elevation of the lower inflatable transverse member to facilitate evacuees' ability to easily stand and move away from the runway end of the slide.

In one example, there is provided an evacuation slide for an aircraft that has first and second longitudinal support beams, a sliding surface supported by the first and second longitudinal support beams, the sliding surface ending prior to a position at which the first and second longitudinal support beams end, such that the sliding surface is shorter than the first and second longitudinal support beams, the first and second longitudinal support beams comprising first and second extension portions, wherein extension portions of the support beams define a passenger receiving area where the sliding surface ends. The slide may also have a lower transverse member positioned near a runway end of the slide, and a ground contact tube positioned transverse to the first and second longitudinal support beams near a runway end of the slide, below the lower transverse member. Upon inflation, the ground contact tube contacts the ground and maintains the elevation of the runway end of the slide, preventing collapse under the evacuation loading.

The lower transverse member and the ground contact tube may be offset from one another. Alternatively, the lower transverse member and the ground contact tube may be aligned with one another.

The slide may also have first and second rail tubes extending the substantial length of the first and second longitudinal support beams. The slide may also have a joint angle formed between the support beams and their extension portions, wherein the ground contact tube is positioned closer to the aircraft than the joint angle. There may be provided a tension band extending the substantial length of the first and second longitudinal support beams. The tension band may have a first securement point near the aircraft and a second securement point at an extension portion. It is possible to provide a plurality of transverse members, with at least one transverse member of the plurality of transverse members comprising the lower transverse member.

The terms “invention,” “the invention,” “this invention” “the present invention,” “disclosure,” “the disclosure,” and “the present disclosure,” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF THE DRAWINGS

FIG. 1 shows a side perspective view of an inflated evacuation slide according to embodiments described herein.

FIG. 2 shows a top perspective view of the evacuation slide of FIG. 1.

FIG. 3 shows a side plan view of the evacuation slide of FIG. 1.

FIG. 4 shows a front plan view of the evacuation slide of FIG. 1.

FIG. 5 shows a side plan cross-sectional view of the evacuation slide of FIG. 1.

FIG. 6 shows a close-up side plan cross-sectional view of the runway end of the evacuation slide of FIG. 1.

FIG. 7 shows a passenger position upon exit during use of the evacuation slide of FIG. 1.

FIG. 8 shows a top plan view of a prior art “pickle fork” slide design, which includes extension portions that extend past the sliding surface.

FIG. 9 shows a side plan view of the prior art slide of FIG. 8.

FIG. 10 shows a side plan view of the prior art slide of FIG. 8 in use during passenger evacuation, illustrating a passenger position upon exit.

### DETAILED DESCRIPTION

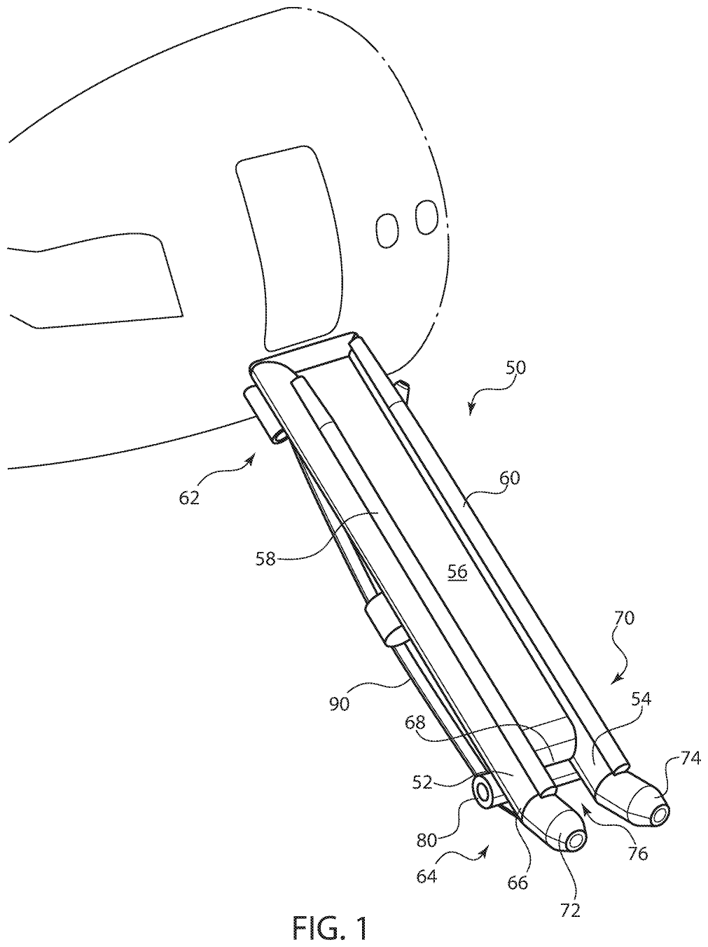

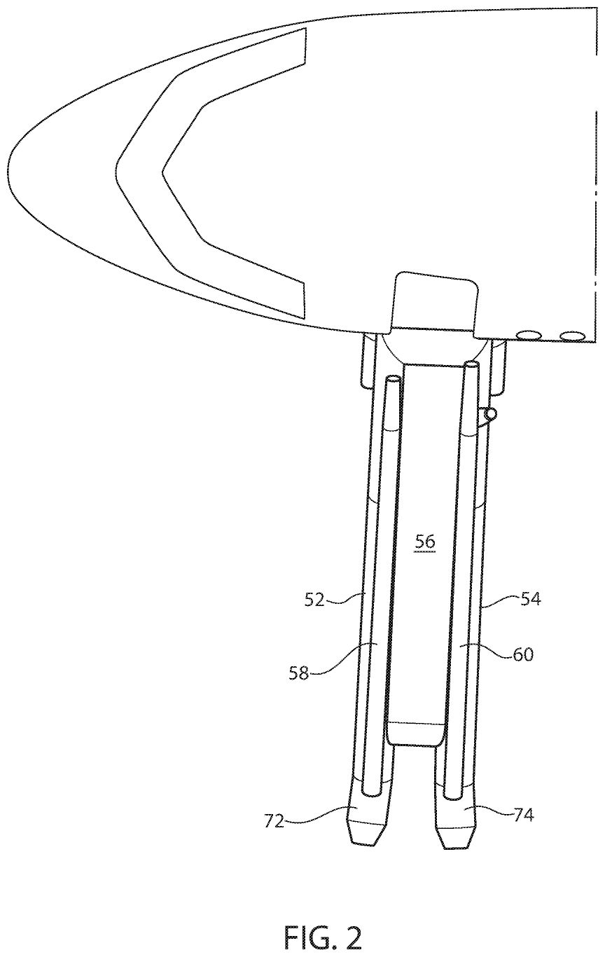

Embodiments of the present disclosure provide an improved runway end slide 50. Although described with respect to an evacuation slide, the features disclosed may also be used in connection with combination slide/rafts. The slide 50 features longitudinal inflatable support beams 52, 54. These support beams 52, 54 may also be referred to as body tubes, as they define left and right side edges of the slide 50. Extending between inflatable support beams 52, 54 is a sliding surface 56. Positioned slightly internal to the support beams 52, 54 are rail tubes 58, 60. These rail tubes 58, 60 are positioned along left and right sides of the slide and can function to contain evacuees in the sliding surface. Rail tubes 58, 60 also lend beam strength to the slide 50. Additionally, rail tubes 58, 60 may provide a “handrail”-like feel to evacuees. In a specific embodiment, the rail tubes 58, 60 extend the substantial longitudinal length of the slide 50. As shown by FIG. 1, rail tube 58 extends from an upper portion 62 of the slide to a lower portion 64 of the slide, ending at joint angle 66 where the support beam 52 bends to reach the ground surface. Rail tube 60 extends similarly. Rail tubes may be provided in differing lengths in order to address clearance of the aircraft door in the open position.

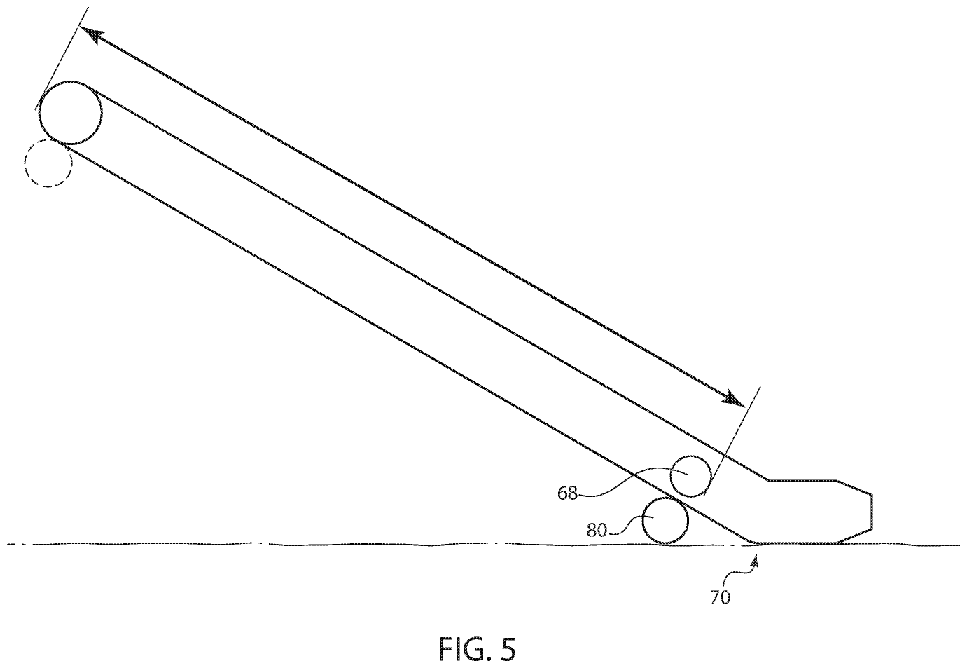

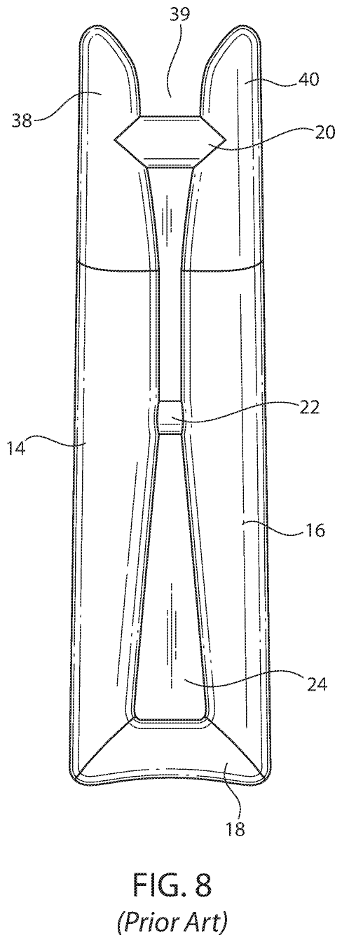

In addition to the longitudinal support beams, the slide 50 also features inflatable transverse members that function to provide transverse structural support. There will generally be an upper transverse member 18, an intermediate transverse member 22, and a lower transverse member 20. A specific lower transverse member 68 is shown by FIGS. 5-7. (The remaining transverse members are not illustrated by the figures, but may be similar to the transverse members shown and described by U.S. Pat. No. 5,875,868 and in prior art FIG. 8.)

The runway end 70 of the slide defines extension portions 72, 74 of the first and second longitudinal support beams 52, 54. The extension portions 72, 74 increase the effective length of the slide and provide an acceptable sliding angle when the slide is used at a sill height above normal level, but the effective length of the slide is not increased. The extension portion 72, 74 create a passenger receiving area 76, defined by the end of the sliding surface 56 and the extension portions 72, 74. The sliding surface 56 ends a few feet before the ground.

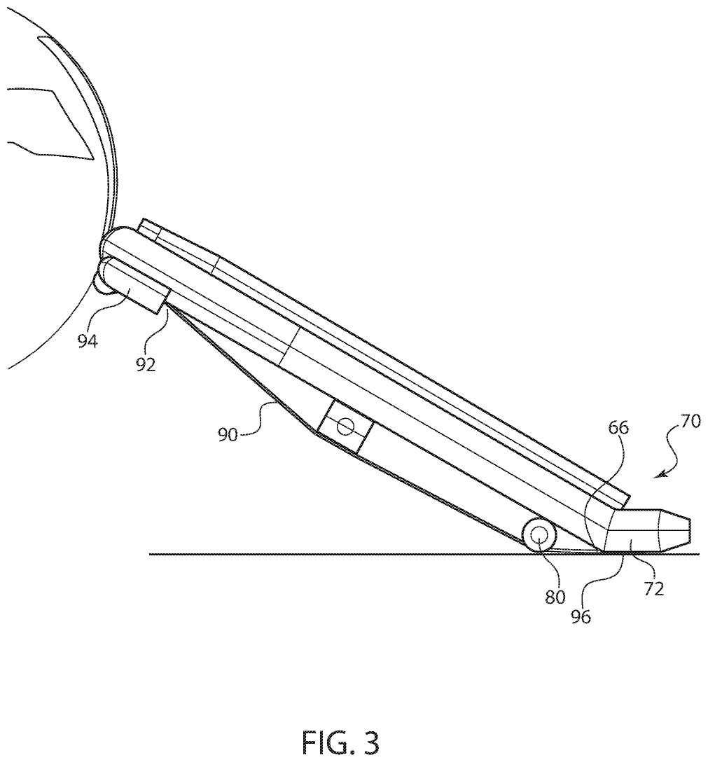

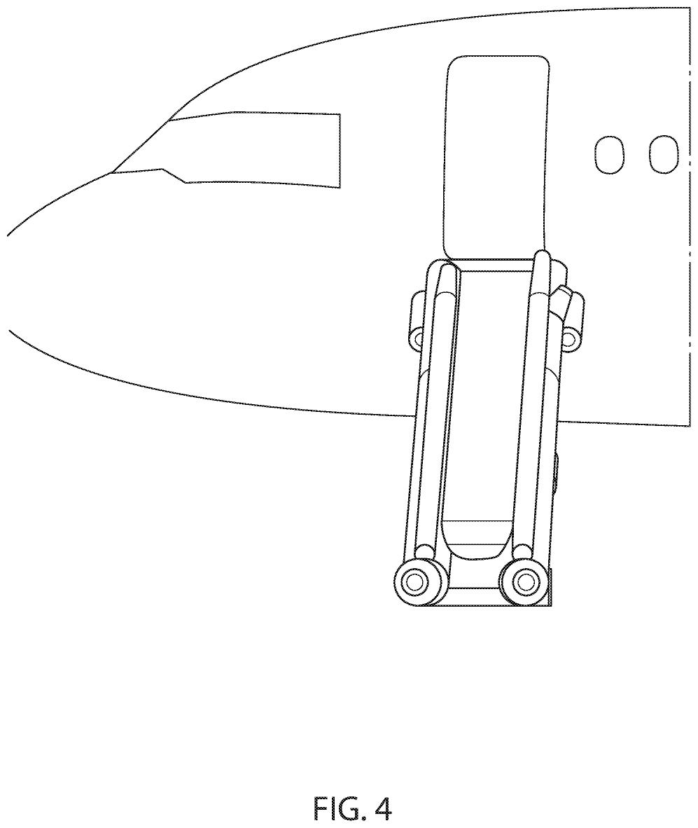

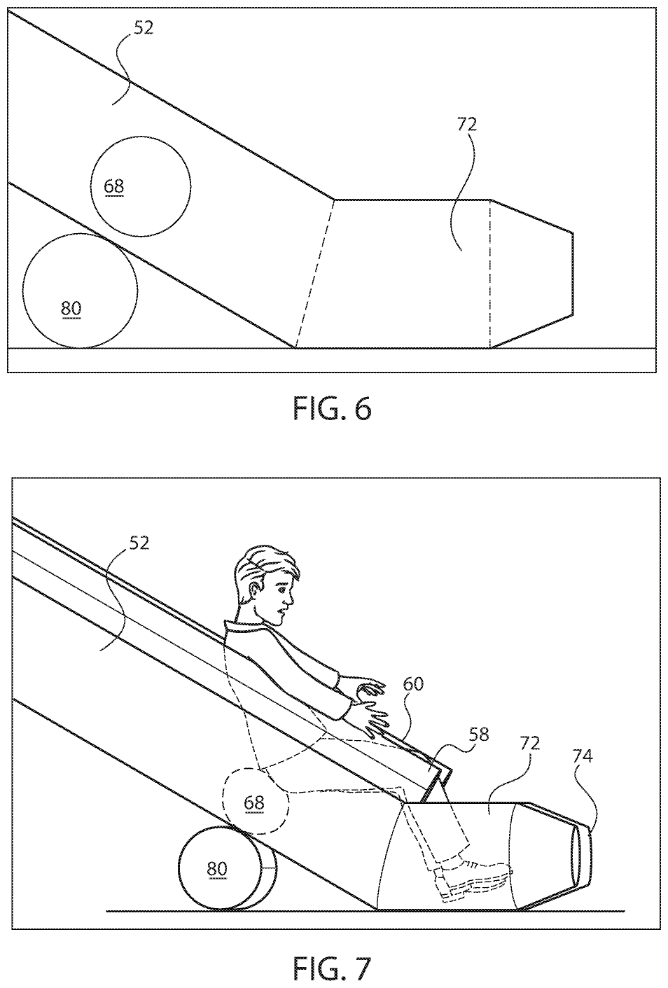

A ground contact tube 80 is positioned transverse to the support beams 52, 54. Ground contact tube 80 is inflatable with the entire slide body. Ground contact tube 80 may have a length that is substantially equal to the width of the slide body. As shown by the side view of FIG. 3, the ground contact tube 80 is positioned below the support beams 52, 54 and slightly rearward (closer to the aircraft side) of the joint angle 66. As shown by the cross-sectional view of FIGS. 5 and 6, the ground contact tube 80 is positioned so that it provides lower support for the lower transverse member 68. The tube 80 is positioned so that it is below the member 68. This allows the tube 80 and the member 68 to be in a stacked configuration, such that weight from an evacuee is supported by both the tube 80 and the member 68, creating a “chair-like” feel at the exit. It is possible for the tube 80 to be slightly offset from the member 68, as shown by side views of FIGS. 5-7. In other words, the additional tube 80 may be positioned so that it is closer to the aircraft than the member 68. In this configuration, central points on each of the tube diameters are not aligned (i.e., they are in different longitudinal planes) such that the tube 80 and the member 68 are slightly offset and stacked. In another example, the tube 80 and the member 68 may be aligned, such that central points on each of the diameters of tube 80 and member 68 are in the same longitudinal plane. The general intent is that the lower transverse member 68 is supported by the ground contact tube 80.

The ground contact tube may have a diameter that is anywhere from 6 inches to 20 inches. The dimensions depend on the sliding angle, slide configuration, and the placement of the tube 80. In one specific example, the tube has a 10-12 inch diameter. In another specific example, the tube has a 12 to 14 inch diameter. Other diameters are possible and considered within the scope of this disclosure.

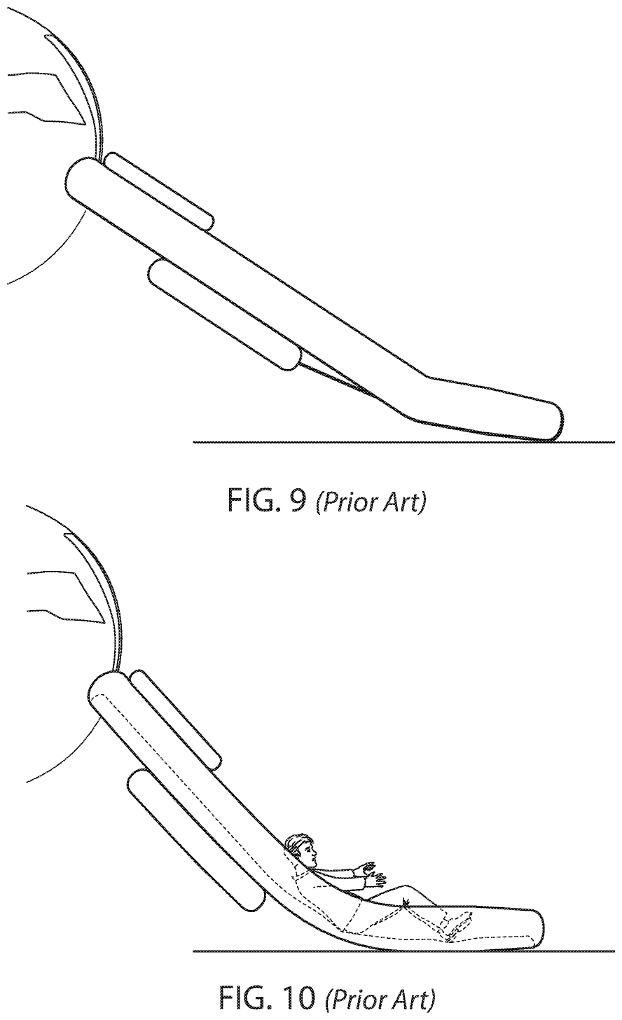

Once inflated, the ground contact tube 80 helps the runway end 70 of the slide to be more rigid. As a passenger is moving along the sliding surface 56, without the presence of the ground contact tube 80, the passenger's weight can cause the lower transverse member 68 to be flush with the ground, as illustrated by prior art FIG. 10. This lowers the passenger's center of gravity much closer to the ground, which can make slide exit potentially more difficult. The passenger may need to pick him/herself up off of the ground, as illustrated by prior art FIGS. 9 and 10. By contrast, the presence of the ground contact tube 80 improves the exit characteristics of the slide. Ground contact tube 80 provides a support to raise the lower transverse member 68 off of the ground. The tubes 68, 80 are stacked, such that they collectively raise the end of the slide and function similar to a chair. The position of the ground contact tube 80 functions almost like chair legs, which can allow the lower transverse member 68 to function as a seat, which is raised via the ground contact tube 80. The passenger is raised above the ground so that his/her feet reach the ground, but the buttocks are raised. The exit motion is thus more similar to a person standing up off of a chair, rather than scrambling up from a lower position on or near the ground. The presence of ground contact tube 80 reduces the effective sliding length (beam) of the slide 50 at normal door sill height. It helps keep the runway end of the sliding surface at seat level so it is easier for the passenger to get to his/her feet. The ground contact tube 80 is generally of a diameter that allows the exit surface to be at chair height.

The figures also illustrate a tension band 90 that runs the full length of the slide. It is generally envisioned that a first tension band would be associated with longitudinal support beam 52 and a second tension band will be associated with longitudinal support beam 54 (although the figures are shown from a side view and only one tension band 90 is illustrated). As shown by FIGS. 1 and 3, the tension band 90 has a first securement point 92 along one of the longitudinal support beams. The tension band extends along the support beam, along a truss tube, wraps around the ground contact tube 80, and has a second securement point 96 at the extension portion 72

Accordingly, the present inventors have designed an improvement to the “pickle fork” evacuation slide that reduces the effective sliding length (beam) and helps improve exit characteristics. This is achieved by adding an additional tube below a lower inflatable transverse member. This effectively shortens the sliding length (beam) and supports the lower inflatable transverse member, preventing collapse of the longitudinal body tube extension portions under load. This additional tube increases or maintains the elevation of the lower inflatable transverse member to facilitate evacuees' ability to easily stand and move away from the runway end of the slide.

Although this description includes a discussion of the additional tube 80 being positioned below the lower transverse member 68, it should be understood that it is possible for the evacuation slide to be manufactured without lower transverse member 68. In this instance, the diameter of the additional tube 80 can be enlarged in order to continue to provide the desired rise at the end of the slide.

The subject matter of certain embodiments of this disclosure is described with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

It should be understood that different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

What is claimed is:

1. An evacuation slide for an aircraft, comprising:
first and second longitudinal support beams;
a sliding surface supported by the first and second longitudinal support beams, wherein the first and second longitudinal support beams extend beyond the end of the sliding surface,
the first and second longitudinal support beams comprising first and second extension portions, wherein the first and second extension portions of the first and second longitudinal support beams define a passenger receiving area where the sliding surface ends;
a lower transverse member positioned near a runway end of the slide; and
a ground contact tube positioned transverse to the first and second longitudinal support beams near a runway end of the slide, below the lower transverse member,
wherein upon inflation, the ground contact tube contacts the ground and supports the runway end of the slide, preventing collapse under load.

2. The slide of claim 1, wherein the lower transverse member and the ground contact tube are offset from one another.

3. The slide of claim 1, wherein the lower transverse member and the ground contact tube are aligned with one another.

4. The slide of claim 1, wherein the lower transverse member and the ground contact tube are stacked with respect to one another.

5. The slide of claim 1, further comprising first and second rail tubes extending the substantial length of the first and second longitudinal support beams.

6. The slide of claim 1, further comprising a joint angle formed between the support beams and their extension portions, wherein the ground contact tube is positioned closer to the aircraft than the joint angle.

7. The slide of claim 1, further comprising a tension band extending the substantial length of the first and second longitudinal support beams.

8. The slide of claim 7, wherein the tension band comprises a first securement point near the aircraft and a second securement point at an extension portion.

9. The slide of claim 1, further comprising a plurality of transverse members, at least one transverse member of the plurality of transverse members comprising the lower transverse member.
